(19) United States
(12) Patent Application Publication
(10) Pub. No.: US 2018/0003447 A1
(43) Pub. Date: Jan. 4, 2018

(54) HEAT-EXCHANGE ELEMENT SUITABLE FOR A HEAT EXCHANGE BETWEEN FIRST AND SECOND FLUIDS, AN EXCHANGER CORE INCLUDING THE HEAT-EXCHANGE ELEMENT AND A HEAT EXCHANGER INCLUDING THE EXCHANGER CORE

(71) Applicant: Valeo Systemes Thermiques, Le Mesnil Saint Denis (FR)

(72) Inventor: Jérôme Mougnier, Prosnes (FR)

(73) Assignee: Valeo Systemes Thermiques, Le Mesnil Saint Denis (FR)

(21) Appl. No.: 15/524,290

(22) PCT Filed: Nov. 4, 2015
(86) PCT No.: PCT/EP2015/075752

§ 371 Date: Aug. 16, 2017

(30) Foreign Application Priority Data
Nov. 4, 2014 (FR) 1460605

(51) Int. Cl. F28F 1/02; F28F 1/08; F28D 7/16; F28D 7/00; F28F 9/00; F28D 21/00; B60H 1/00; F28F 9/02

(52) U.S. Cl. CPC F28F 1/022; F28D 7/0041; F28D 7/005; F28F 1/08; F28F 9/001; F28D 7/1684; B60H 1/00342; F28F 9/0256; F28D 2021/0084

(57) ABSTRACT

The present invention concerns a heat-exchange element (31, 131) for a heat exchanger (1) enabling heat exchange between a first fluid and a second fluid, said heat-exchange element (31, 131) being designed to guide said first fluid through the inside of said heat-exchange element (31, 131) and said second fluid around the outside of said heat-exchange element, said heat-exchange element (31, 131) including at least one first duct (42, 43, 44, 45; 141, 142, 143) having a first essentially cylindrical wall and a second duct (42, 43, 44, 45; 141, 142, 143) having a second essentially cylindrical wall, the at least first and second ducts (42, 43, 44, 45; 141, 142, 143) being connected to one another by a portion of the first wall adjacent to a portion of the second wall.

### DOMAIN OF THE INVENTION

The present invention relates to a heat-exchange element designed to enable heat exchange between first and second fluids. More specifically, the invention relates to a heat-exchange element designed to guide a first fluid through the inside of same and a second fluid around the outside of same to enable heat exchange through the wall of the heat-exchange element.

### PRIOR ART

In an air conditioning system, for example an air conditioning system designed for a motor vehicle, a refrigerant used to cool the passenger compartment of said motor vehicle flows through the inside of a heat exchanger, such as a condenser, during a cooling cycle.

In the prior art, it is known to cool a refrigerant using a heat exchanger, said heat exchanger being designed to enable a heat exchange between the refrigerant and a fluid, such as water, to cool said refrigerant.

For this purpose, the heat exchanger in the prior art has two separate circuits, one circuit intended for the refrigerant and the other circuit intended for the fluid used to cool the refrigerant.

Accordingly, the prior art discloses the use of a heat exchanger including an exchange core in which said exchange core includes a stack of tubes. The refrigerant can flow through the inside of the tubes, from a first end towards a second end of the tubes. The fluid used to cool the refrigerant flows in the opposite direction to the refrigerant, from the second end towards the first end of the tubes, between the two adjacent tubes.

In the prior art, the tubes have a wall of a given thickness designed to withstand the high pressure to which the refrigerant flowing inside said tubes is subjected. The heat exchange between the refrigerant and the fluid occurs through this wall. In order to improve the efficiency of the heat exchange, it is possible to provide the inner wall of the tubes with protuberances projecting towards the inside of the tube in order to increase the contact surface inside the tubes. However, this solution is expensive and complex to implement.

Solutions designed to improve the heat exchange between a first fluid flowing through the inside of an exchange element of a heat exchanger and the second fluid flowing around the outside of said heat exchanger are required to increase the efficiency of the heat exchange.

### PURPOSE OF THE INVENTION

The present invention concerns a heat-exchange element that is designed to improve the efficiency of the heat exchange between the first fluid flowing through the inside of the heat-exchange element and a second fluid flowing around the outside of said heat-exchange element.

Accordingly, the invention concerns a heat-exchange element for a heat exchanger enabling heat exchange between a first fluid and a second fluid, said heat-exchange element being designed to guide said first fluid through the inside of said heat-exchange element and said second fluid around the outside of said heat-exchange element, said heat-exchange element including at least one first duct having a first essentially cylindrical wall and a second duct having a second essentially cylindrical wall, the at least first and second ducts being connected to one another by a portion of the first wall adjacent to a portion of the second wall.

According to one embodiment of the invention, the heat-exchange element includes a plurality of ducts, the odd-numbered ducts being positioned on a first level and the even-numbered ducts being interconnected between the odd-numbered ducts on a second level.

According to one embodiment of the invention, the heat-exchange element extends from a first end towards a second end, in which the heat-exchange element has at least one undulation between this first end and this second end.

According to one embodiment of the invention, the heat-exchange element the first and/or second ducts are of constant thickness.

According to one embodiment of the invention, the exchange core for a heat exchanger includes at least one first heat-exchange element and one second heat-exchange element, in which the at least first and second heat-exchange elements are positioned one on top of the other.

According to one embodiment of the invention, the heat exchanger includes the exchange core.

According to one embodiment of the invention, the heat exchanger is designed for a heat exchange between a refrigerant and glycol water

According to a second aspect, the invention relates to an air conditioning system for a motor vehicle including the heat exchanger.

### SHORT DESCRIPTION OF THE DRAWINGS

The objectives, purpose and characteristics of the present invention, as well as the advantages thereof, are set out more clearly in the description below of the preferred embodiments of a heat exchanger according to the invention, made with reference to the drawings, in which:

FIG. 1 is an exploded view of a heat exchanger according to the present invention, showing the different components of said heat exchanger,

FIG. 2 shows a first embodiment of the heat-exchange element according to the present invention,

FIG. 3 is a detailed view of the heat-exchange element in FIG. 2,

FIG. 4 shows a second embodiment of the heat-exchange element according to the present invention, and

FIG. 5 is a detailed view of the heat-exchange element in FIG. 4.

### DETAILED DESCRIPTION OF THE EMBODIMENTS

The description below is intended to explain the invention clearly and completely, in particular using examples, but should not be understood to limit the scope of protection for the specific embodiments and examples set out below.

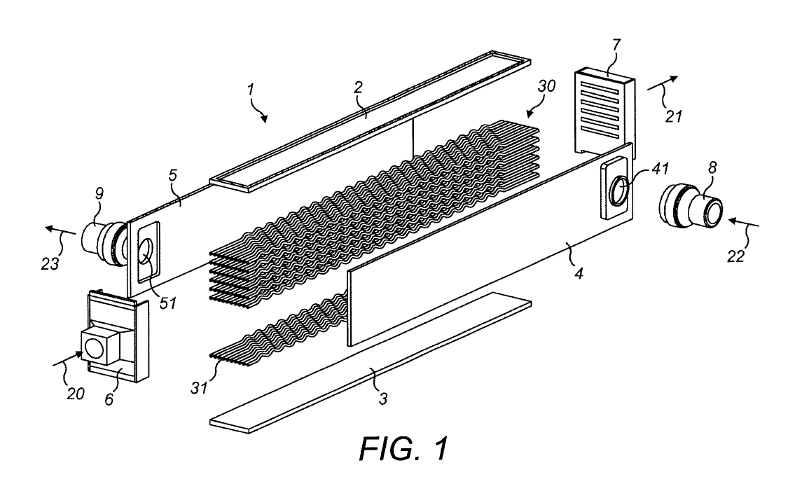

FIG. 1 is an exploded view of a heat exchanger 1 according to the invention. The heat exchanger 1 is particularly suited for use during a cooling cycle of an air conditioning system, for example inside a motor vehicle.

As shown in FIG. 1, the heat exchanger 1 is designed to receive the refrigerant in the direction of the arrow 20, at relatively high temperature and pressure. The heat exchanger 1 includes a set of tubes spaced out from one another and designed to withstand the relatively high temperature and relatively high pressure of the refrigerant. The refrigerant is guided into the heat exchanger 1 from the inlet of same towards an outlet in the direction of the arrow 21 in FIG. 1. In order to cool the refrigerant, a coolant, such as water, is put into the heat exchanger 1 in the direction of the arrow 22, and the coolant flows in the opposite direction to the refrigerant, thereby enabling a heat exchange between the refrigerant and the coolant within the heat exchanger 1. The coolant is then guided towards an outlet in the direction of the arrow 23. The heat exchanger 1 is thus designed to facilitate the movement of the coolant into the space between the different tubes used to circulate the refrigerant.

The heat exchanger 1 includes a housing including an upper wall 2, a lower wall 3 and two side walls 4, 5. At a first end, the heat exchanger 1 includes a first collector 6 forming an inlet used for circulating the refrigerant. At the opposite end, the heat exchanger 1 has a second collector 7 forming an outlet used for circulating the refrigerant. The wall 4 is provided with an opening 41 designed to receive a connector 8 used as an inlet for the coolant. Similarly, the wall 5 is provided with an opening 51 designed to receive a connector 9 used as an outlet for the coolant. As shown in FIG. 1, the collectors 6, 7 and the connectors 8, 9, forming the different inlets and outlets of the heat exchanger 1, are positioned such as to enable the refrigerant and the coolant to flow in opposite directions inside the heat exchanger 1. The heat exchanger 1 contains an exchange core 30 comprising a stack of heat-exchange elements or tubes 31. Two adjacent heat-exchange elements 31 create a space through which the coolant can flow. As shown in FIG. 1, the exchange core 30 includes, by way of example, seven heat-exchange elements 31 positioned on top of one another. The number of heat-exchange elements 31 used to form an exchange core may vary as a function of the use of the heat exchanger 1.

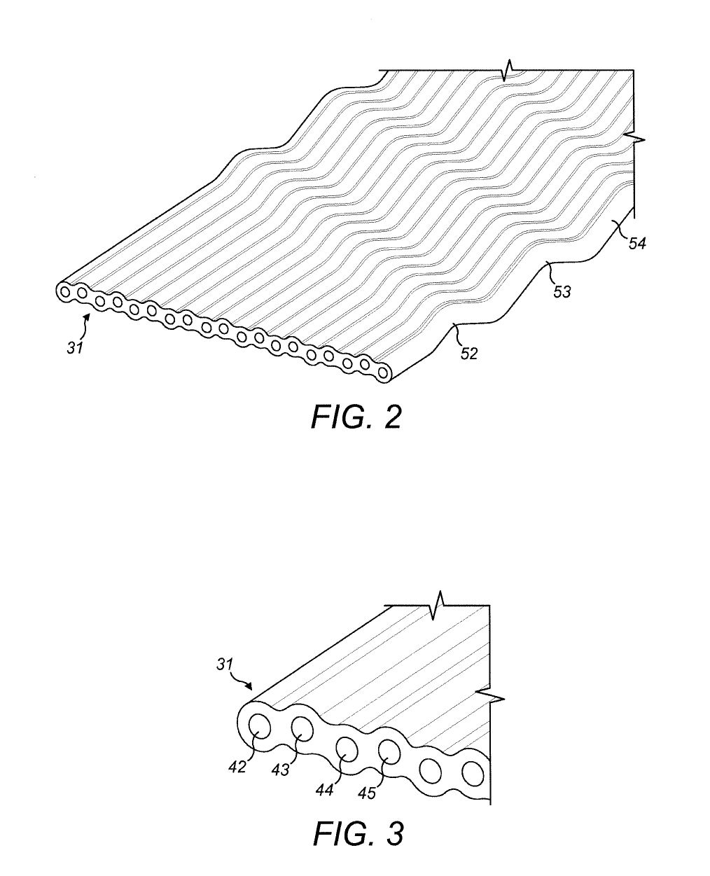

FIG. 2 shows a detailed view of the heat-exchange element 31 according to a first embodiment of the invention. The heat-exchange element 31 includes a plurality of ducts, as described below, enabling the refrigerant to flow inside said heat-exchange element 31.

FIG. 3 shows a detail of the heat-exchange element 31. The heat-exchange element 31 includes a plurality of ducts 42, 43, 44, 45. The ducts 42, 43, 44, 45 enable the refrigerant to be guided inside said ducts from a first end of the heat-exchange element 31 towards the opposite end of the heat-exchange element 31. The first measure increases the outer surface of the heat-exchange element 31. The even-numbered ducts 42, 44 are positioned in a first horizontal plane and the odd-numbered ducts 41, 45 are positioned in a second horizontal plane. Each duct 42, 43, 44, 45 is essentially cylindrical, such as to form a tube. The different ducts 42, 43, 44, 45 are each positioned in vertical planes that are parallel to one another. The walls of said ducts 42, 43, 44, 45 are connected to one another to form the heat-exchange element 31.

The alternation of the first and second horizontal planes of the ducts 42, 43, 44, 45 increases the outer surface of the heat-exchange element 31, thereby increasing the heat exchange potential through the walls of the ducts 42, 43, 44, 45 between the refrigerant flowing through the inside of the ducts and the coolant flowing around the outside of said ducts 42, 43, 44, 45.

As shown in FIG. 2, the heat-exchange element 31 is provided with several undulations 52, 53, 54. These undulations 52, 53, 54 increase the length of the path followed by the refrigerant inside the different ducts 42, 43, 44, 45 from the first end towards the second end of the heat-exchange element 31. This increases the outer surface of the heat-exchange element 31. As a result, the quantity of heat exchanged between the refrigerant and the coolant is also increased.

The combination of the technical features described above regarding the alternation of the horizontal planes of the different ducts 42, 43, 44, 45 and the presence of undulations 52, 53, 54 guarantees an optimal heat exchange between the refrigerant and the coolant used in the heat exchanger 1 according to the present invention.

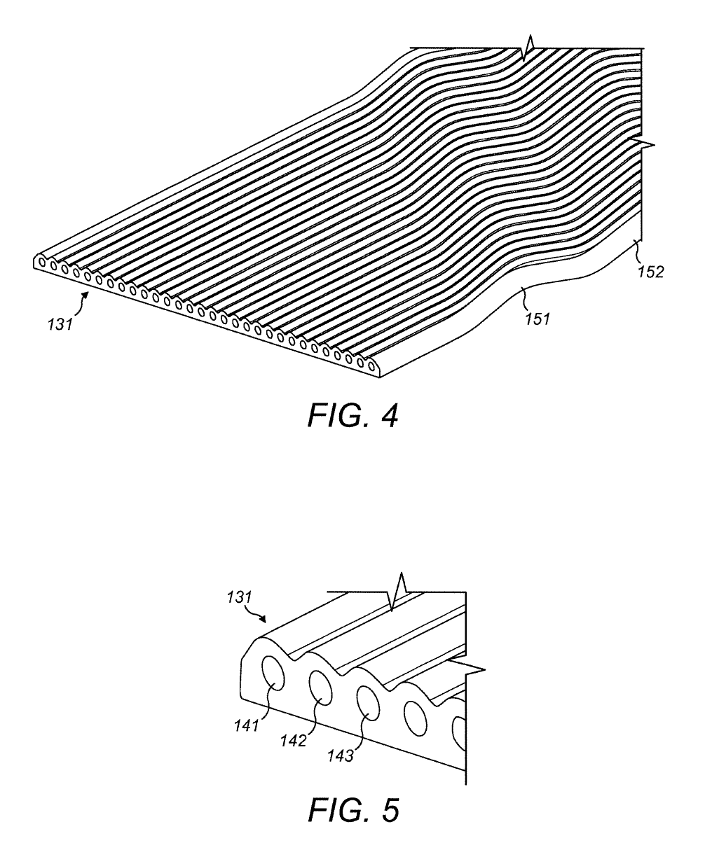

FIG. 4 shows an alternative embodiment of the heat-exchange element according to the invention. Accordingly, FIG. 4 shows a heat-exchange element 131 including a plurality of ducts, as described below, enabling the refrigerant to flow inside said heat-exchange element 131. As shown in detail in FIG. 5, the heat-exchange element 131 includes a plurality of ducts 42, 43, 44, 45. The ducts 42, 43, 44, 45 enable the refrigerant to be guided inside said ducts from a first end of the heat-exchange element 131 towards the opposite end of the heat-exchange element 31.

The heat-exchange element 131 includes ducts 141, 142, 143 that are essentially cylindrical such as to form tubes having an essentially flat inner surface. The ducts 141, 142, 143 are positioned in the same horizontal plane and in different vertical planes that are parallel to one another. The heat-exchange element 131 is provided with undulations 151, 152 between the first end and the second end of same.

Moreover, the elements 31 and/or 131 include first and/or second ducts 42, 43, 44, 45, 141, 142, 143 of constant thickness.

The combination of the technical features described above regarding the position of the ducts 141, 142, 143 in the same horizontal plane, the presence of undulations 151, 152 and the essentially flat inner surface of the ducts guarantee an optimal heat exchange between the refrigerant and the coolant used in the heat exchanger 1 according to the present invention.

1. A heat-exchange element for a heat exchanger enabling heat exchange between a first fluid and a second fluid, said heat-exchange element comprising:
at least one first duct having a first substantially cylindrical wall; and
a second duct having a second substantially cylindrical wall,
the heat-exchange element being configured to guide said first fluid through the inside of said heat-exchange element and to guide said second fluid around the outside of said heat-exchange element,
the at least first and second ducts being connected to one another by a portion of the first substantially cylindrical wall adjacent to a portion of the second substantially cylindrical wall.

2. The heat-exchange element as claimed in claim 1, in which the heat-exchange element includes a plurality of ducts, wherein odd-numbered ducts are positioned on a first level and even-numbered ducts are interconnected between the odd-numbered ducts on a second level.

3. The heat-exchange element as claimed in claim 1, in which the heat-exchange element extends from a first end towards a second end, in which the heat-exchange element has at least one undulation between the first end and the second end.

4. The heat-exchange element as claimed in claim 1, in which the first and/or second ducts are of a constant thickness.

5. An exchange core for a heat exchanger comprising at least one first heat-exchange element and one second heat-exchange element as claimed in claim 1, in which the at least first and second heat-exchange elements are positioned one on top of one another.

6. A heat exchanger including the exchange core as claimed in claim 5.

7. The heat exchanger as claimed in claim 6, in which the heat exchanger exchanges heat between a refrigerant and glycol water.
